(19) United States
(12) Patent Application Publication
(10) Pub. No.: US 2004/0150898 A1
(43) Pub. Date: Aug. 5, 2004

(54) ADJUSTING APPARATUS FOR LIGHT VALVE

(76) Inventor: Wen-Ching Ho, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,280

(22) Filed: Dec. 3, 2003

(30) Foreign Application Priority Data
Dec. 9, 2002 (TW) 091220193

(51) Int. Cl. G02B 7/02

(52) U.S. Cl. 359/811

(57) ABSTRACT

An adjusting apparatus comprises a base plate, two pairs of adjusting modules and repositioning module which are accordance with each other, and a light valve clipped between the adjusting module and the repositioning module. The adjusting module controls the light valve to move along one dimension and the light valve can be elastically returned by the repositioning module so that the position of light valve can be adjusted to make the light beam precisely project on the surface of the light valve. In addition, the two modules are placed on the same plane of the base plate so that the two-dimensional adjustment can do on one plane to shrink the thickness and volume of the adjusting apparatus.

### BACKGROUND OF INVENTION

1. Field of the Invention

The present invention relates to an adjusting apparatus, and more particularly to an adjusting apparatus for a light valve to adjust the position of the light valve in the projection display apparatus.

2. Description of the Prior Art

Referring to FIG. 1 and FIG. 2, a fixing apparatus for a light valve of the prior art firstly mounts the light valve 1 into a clipped device 2, then, places the clipped device 2 into a container 4 of an optical engine cover 3 and finally sticks the printed circuit broad (not shown in drawing) to the outside of the light valve 1 and to openings 5 of the optical engine cover 3. Hence, the light valve 1 assembly can't adjust the position.

However, the position of the light valve 1 directly affects the precision that a light beam provided by a light source impinges to the surface of the light valve. Hence, during the assembling, the light valve orientation need to precisely adjust so that the light beam can precisely project on the surface of the light valve to keep the illumination performance and raise quality of images.

### SUMMARY OF INVENTION

An object of the present invention is to provide an adjusting apparatus for a light valve, by means of rotating adjusting devices, sliding bases are pushed in accordance with the elasticity of the elastic devices to simply adjust the position of the light valve.

Another object of the present invention is to provide an adjusting apparatus for a light valve. By means of sliding bases and fixing bases, adjusting modules with different displacement directions can be placed on the same plane so that can shrink the thickness and volume of the adjusting apparatus.

Still another object of the present invention is to provides an adjusting apparatus for a light valve, which can be place inside an optical engine of the projection system to adjust the position of the light vale so that the light beam provided by the light source can precisely project on the surface of the light valve to raise the illumination performance of the projection system.

Further object of the present invention is to provide an adjusting apparatus for a light valve, which can be placed inside the optical engine of the projection system to shrink the whole volume of the projection system.

To achieve the above and other objects, the present invention provides an adjusting apparatus for a light valve, which comprises a base plate, at least one adjusting module upon the base plate, repositioning modules in accordance with the adjusting modules, a light valve clipped between the adjusting modules and the repositioning modules. The adjusting module comprises a fixing base, a sliding base, and an adjusting device. The fixing base is fixed on the surface of the base plate, which has a cavity on a side surface faced to the light valve. The sliding base is placed inside the cavity. The adjusting device is screwed to the fixing base and has one end pressing to one side of the sliding base, the other side of the sliding base is pressing to the light valve. The repositioning module comprises a fixing base, a sliding base and at least one elastic device. The fixing base is fixed on the surface of the base plate. One end of the elastic device is connecting to the fixing base and the other end is pressing to one side of the sliding base, the other side of the sliding base is pressing to the light valve.

### BRIEF DESCRIPTION OF DRAWINGS

The above and other objects, advantages, and features of the present invention will be understood from the following detailed description of the invention when considered in connection with the accompanying drawings below.

FIG. 1 is a perspective view showing a prior art adjusting apparatus for a light valve.

FIG. 2 is an explored view showing a prior art projection apparatus for a light valve.

FIG. 3 is a perspective view showing an adjusting apparatus for a light valve of the present invention.

FIG. 4 is an explored view showing an adjusting apparatus for a light valve of the present invention.

FIG. 5A is a top view showing an adjusting apparatus for a light valve of the present invention.

FIG. 5B is an A-A sectional view in FIG. 5A.

FIG. 6 is an explored view showing an elastic piece of an adjusting apparatus of the present invention.

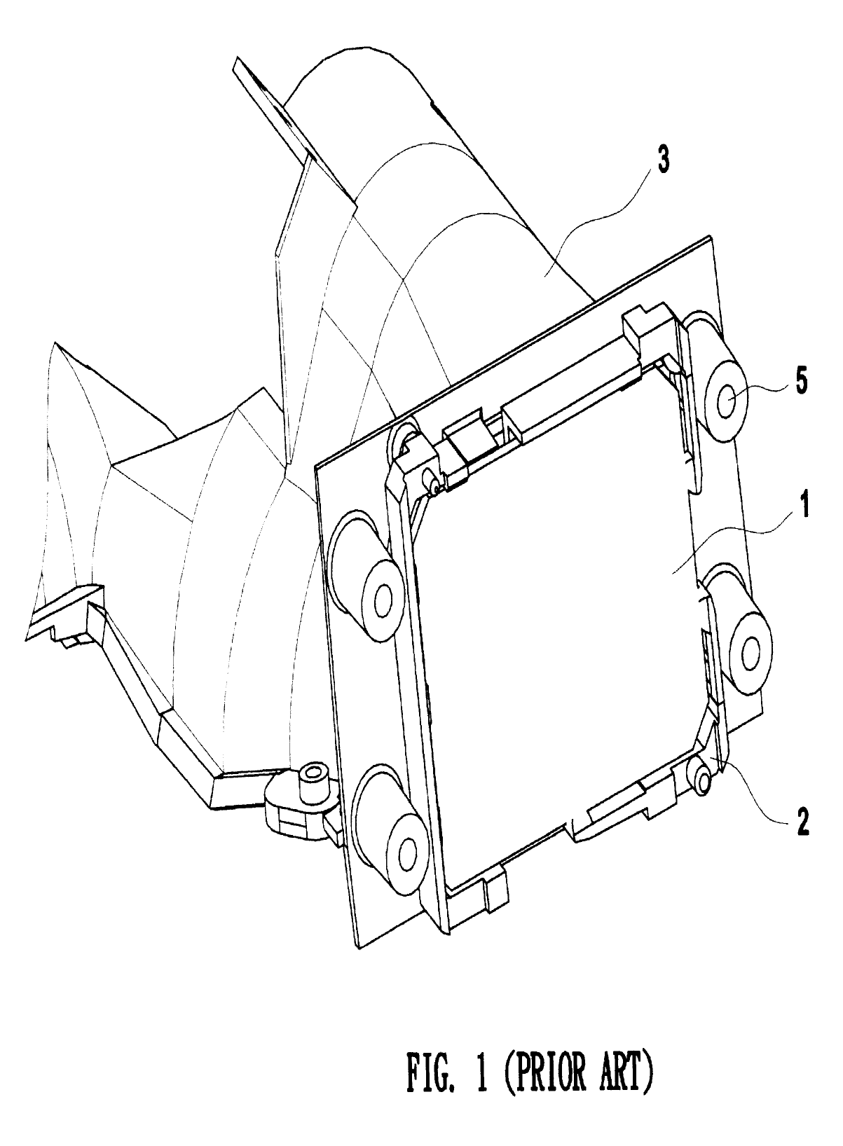

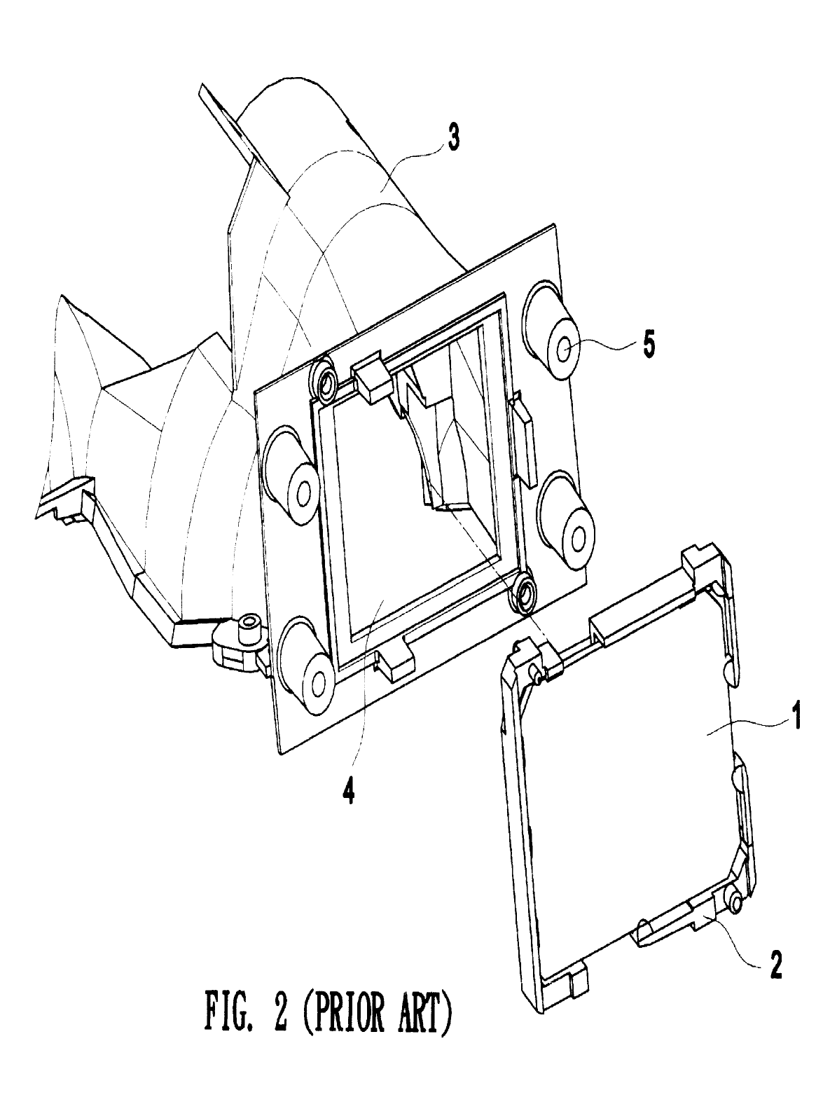

### DETAILED DESCRIPTION

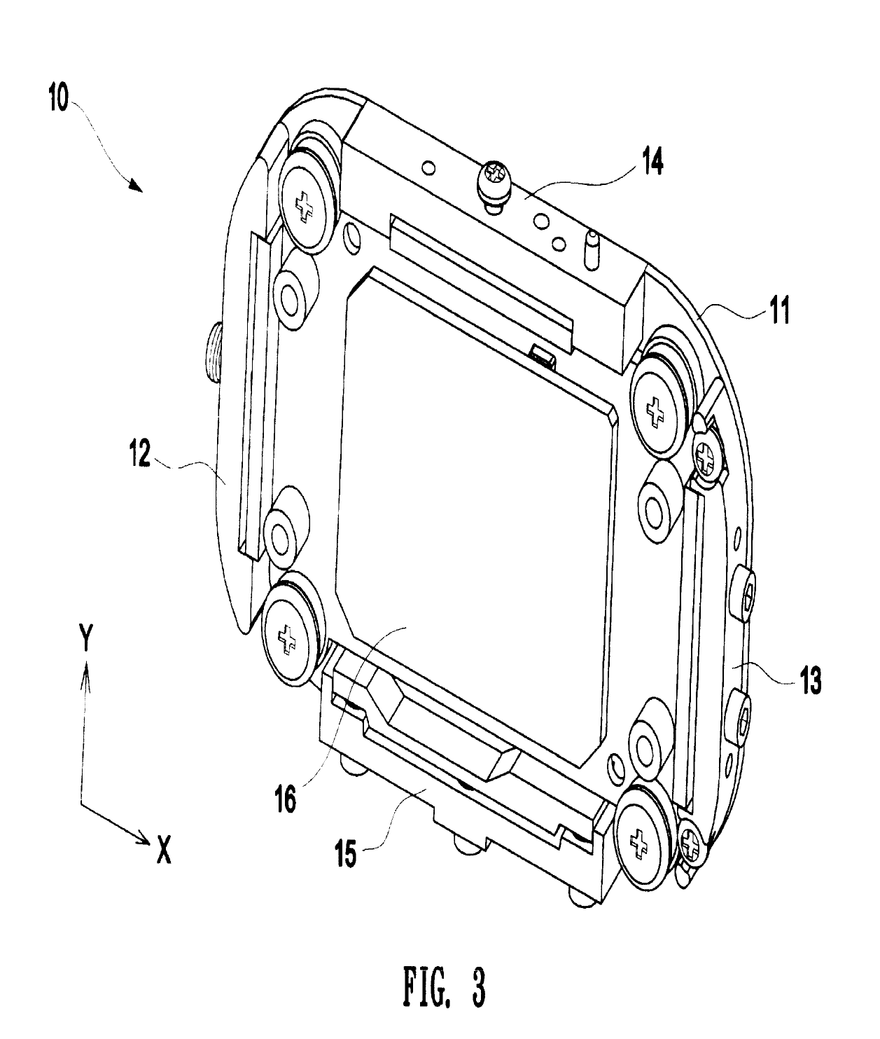

Referring to FIG. 3, an adjusting apparatus 10 for light valve comprises a base plate 11, a pair of a first adjusting module 12 and a repositioning module 13, another pair of second adjusting module 14 and second repositioning module 15, and a light valve 16 (e.g. digital micro-mirror device, DMD). The light valve 16 is clipped between the adjusting modules 12,14 and the repositioning modules 13,15.

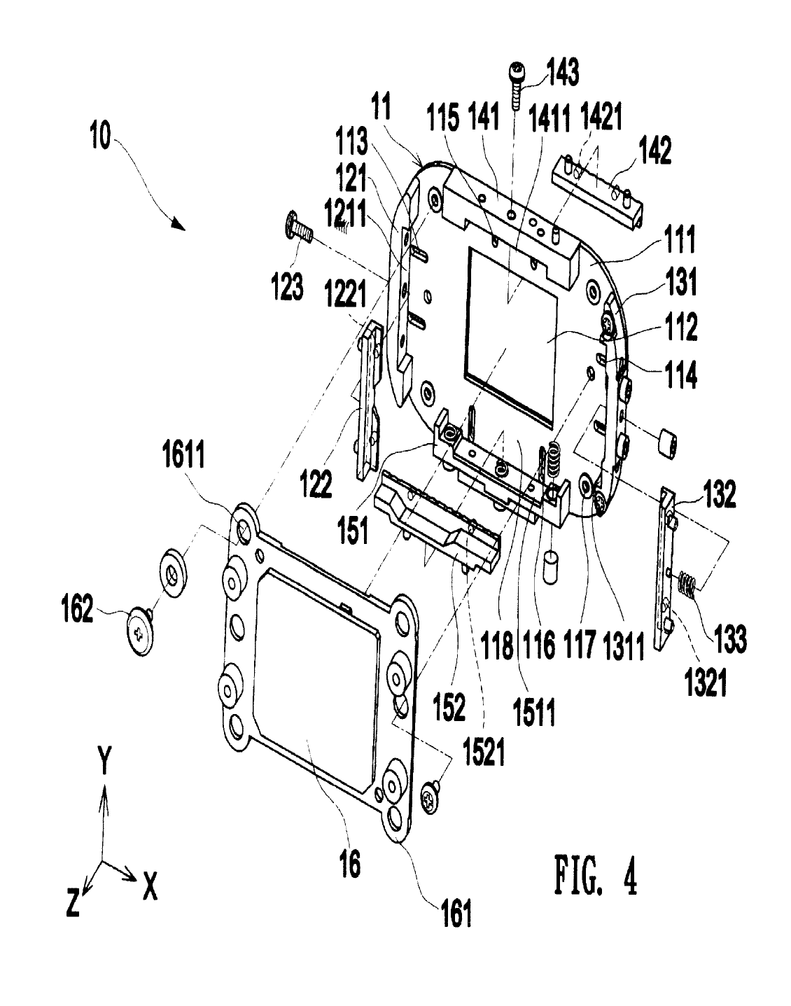

Referring to FIG. 4, the base plate 11 has a surface 111. The surface 111 has a window 112 in accordance with the light valve 16. The first adjusting module 12 and the first repositioning module 13 are on opposite edges of the surface 111 of the base plate 11. The first adjusting module 12 comprises a fixing base 121, a L-shaped sliding base 122 and an adjusting device 123. The fixing base 121 is fixed on the surface 111 of the base plate 11, which has a cavity 1211 on a side surface faced to the light valve 16. The sliding base 122 is placed inside the cavity 1211. Surfaces of the sliding base 122 and the base plate 11 respectively have guide-pins 1221 and guide-grooves 113 according to each other. Further, on surfaces of the sliding base 122 and the fixing base 121 can respectively have guide-pins and guide-grooves according to each other. The length direction of the guide grooves 113 is parallel to the displacement direction of the adjusting device 123. The adjusting device 123 is screwed to the fixing base 121 and has one end pressing to the sliding base 122, and the displacement direction of the adjusting device 123 is parallel to an X-axis direction. By means of rotating the adjusting device 123, the sliding base 122 moves along the X-axis to push the light valve 16.

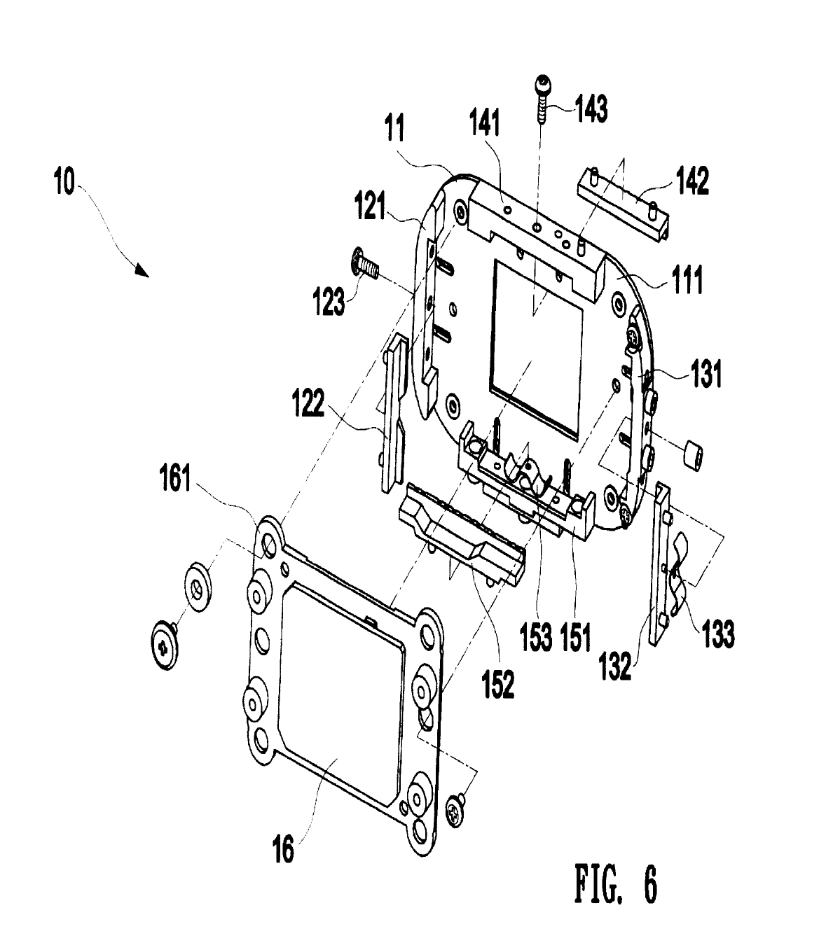

In addition, the first repositioning module 13 comprises a fixing base 131, a sliding base 132 and at least one elastic device 133. The fixing base 131 is fixed on the surface 111 of the base plate 11, which has a cavity 1311 on a side surface faced to the light valve 16. The sliding base 132 is placed inside the cavity 1311. Surfaces of the sliding base 132 and the base plate 11 respectively have guide-pins 1321 and guide-grooves 114 according to each other. Guide-pins and guide-grooves can also be respectively installed on surfaces of the sliding base 132 and the fixing base 131 for substitution. The length direction of the guide grooves 114 is parallel to the length direction of other guide grooves 113. One end of the elastic device 133 is connecting to the fixing base 131 and the other end is pressing to the sliding base 132. The elastic device 133 can be a spring (shown in FIG. 4) with elastic deformation or an elastic piece (shown in FIG. 6).

Referring to FIG. 4, another pair of the second adjusting module 14 and the second repositioning module 15 are on opposite edges of the surface 111 of the base plate 11 and perpendicular to the first adjusting module 12 and the first repositioning module 13. The second adjusting module 14 comprises a fixing base 141, a L-shaped sliding base 142 and an adjusting device 143. The fixing base 141 is fixed on the surface 111 of the base plate 11, which has a cavity 1411 on a side surface faced to the light valve 16. The sliding base 142 is placed inside the cavity 1411. Surfaces of the sliding base 142 and the base plate 11 respectively have guide-pins 1421 and guide-grooves 115 according to each other. Guide-pins and guide-grooves can also be respectively installed on surfaces of the sliding base 142 and the fixing base 141 for substitution. The length direction of the guide grooves 115 is parallel to the displacement direction of the adjusting device 143. The adjusting device 143 is screwed to the fixing base 141 and has one end pressing to the sliding base 142, and the displacement direction of the adjusting device 143 is parallel to a Y-axis direction. By means of rotating the adjusting device 143, the sliding base 142 moves along the Y-axis to push the light valve 16.

In addition, the second repositioning module 15 comprises a fixing base 151, a sliding base 152 and at least one elastic device 153. The fixing base 151 is fixed on the surface 111 of the base plate 11, which has a cavity 1511 on a side surface faced to the light valve 16. The sliding base 152 is placed inside the cavity 1511. Surfaces of the sliding base 152 and the base plate 11 respectively have guide-pins 1521 and guide-grooves 116 according to each other. Guide-pins and guide-grooves can also be respectively installed on surfaces of the sliding base 152 and the fixing base 151 for substitution. The length direction of the guide grooves 116 is parallel to the length direction of other guide grooves 115. One end of the elastic device 153 is connecting to the fixing base 151 and the other end is pressing to the sliding base 152. The elastic device 133 can be a spring with elastic deformation or an elastic piece.

Furthermore, the light valve 16 is placed upon a fixing plate 161. Four edges of the fixing plate 161 have opening 1611. A fixing device 162 passes through the opening 1611 and screws to a hole 117 of the surface 111 of the base 11. The diameter of the fixing device 162 is smaller than the diameter of the opening 1611 so that the fixing plate 161 can be moved. The fixing plate 161 is placed inside a hold space 118 around by the first adjusting module 12, the first repositioning module 13, the second adjusting module 14, and the second repositioning module 15. The fixing plate 161 is placed on the sliding base 122,132,142, and 152 to limit the Z-axis displacement, and each one side surface of the sliding base 122,132,142, and 152 is respectively pressing to a surface of the fixing plate 161. The sliding base 161 moves to push the fixing plate 161.

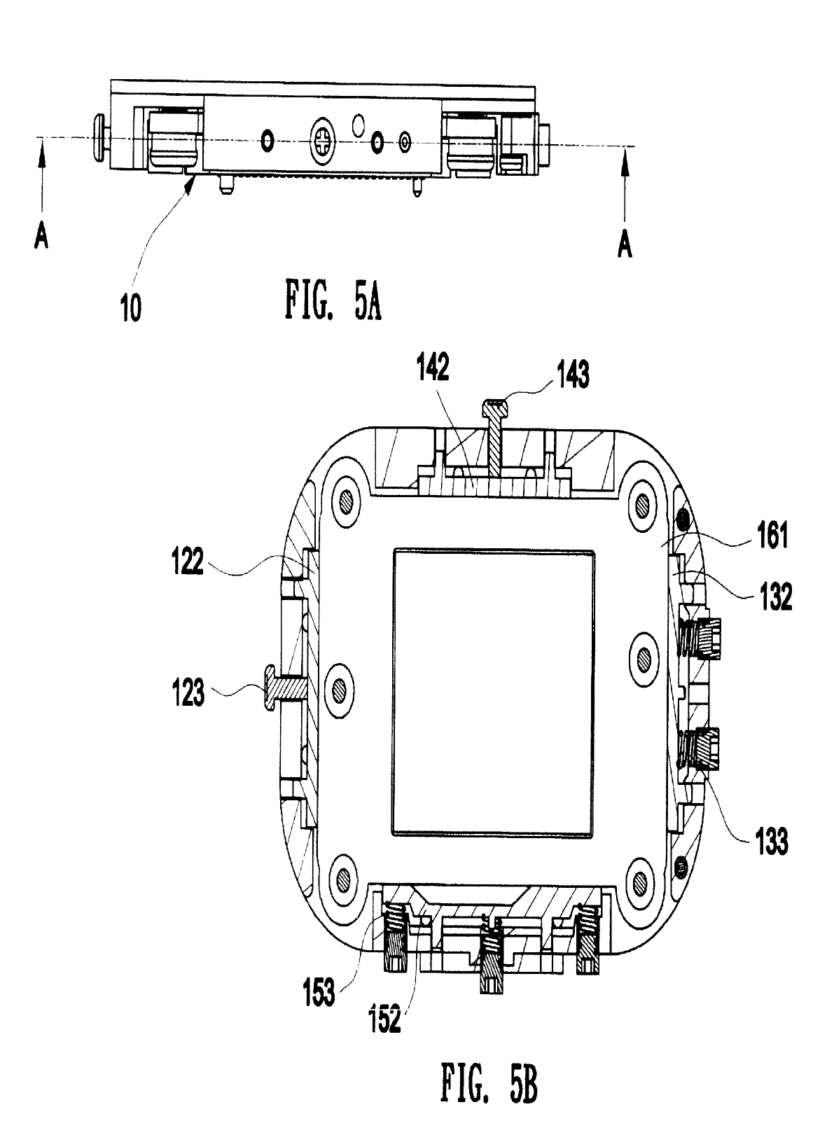

Referring to FIG. 5A and FIG. 5B, as rotating the X-axis adjusting device 123, one end of the adjusting device 123 pushes the sliding base 122 and, at the same time, pushes the fixing plate 161 to move along the X-axis. Meanwhile, the fixing plate 161 presses to another side of the sliding base 132 to compress the elastic device 133 so that the position of the light valve 16 upon the fixing plate 161 can be adjusted along the X-axis. On the contrary, when the adjusting device 123 is reversely rotated, the pressed elastic device 133 can go back to push the sliding base 132 by means of elasticity so that the fixing plate 161 can reversely move along the X-axis. Besides, as rotating the Y-axis adjusting device 143, one end of the adjusting device 143 pushes the sliding base 142 and, at the same time, pushes the fixing plate 161 to move along the Y-axis. Meanwhile, the fixing plate 161 presses to the sliding base 152 to press the elastic device 153 so that the position of the light valve 16 upon the fixing plate 161 can be adjusted along the Y-axis. On the contrary, when the adjusting device 143 is reversely rotated, the pressed elastic device 153 can go back to push the sliding base 152 by means of elasticity so that the fixing plate 161 can reversely move along the Y-axis. Hence, after the light valve 16 connects to the fixing plate 161, pressing the X-axis adjusting device 123 and Y-axis adjusting device 143 and repositioning the elastic devices 133,153 provide the two-dimensional position adjustment for the light valve 16.

In addition, the two pairs of adjusting modules with the repositioning module, respective, adjust the X-axis and Y-axis position of the light valve. The first adjusting module 12 with the first repositioning module 13 adjusts the X-axis position of the light valve. The second adjusting module 14 with the first repositioning module 15 adjusts the Y-axis position of the light valve. The adjusting modules 12 and 14 are on the same surface 111 of the base plate 11. The sliding bases 122, 132, 142, and 152 push the fixing plate 161 to adjust the position of the light valve 16 on one plane for the two-dimensional adjustment so that the thickness and volume of the adjusting apparatus can be shrunk.

The adjusting apparatus 10 for the light valve of the present invention is installed in the optical engine (not shown in drawing) of projection system. After assembling, the position of the light valve can be adjusted by the adjusting apparatus 10 of the present invention so that the light beam provided by the light source can precisely project on the surface of the light valve to raise the illumination performance and quality of images. In addition, the adjusting apparatus 10 for the light valve of the present invention can do the two-dimensional adjustment on one plane to shrink the thickness and reduce the whole volume of the projection system.

It will be apparent to those skilled in the art that in light of the forgoing disclosure, many alternations and modifications are possible in the practice of this invention without departing from the spirit or scoop thereof. Accordingly, the scoop of the invention is to be considered in accordance with the substance defined in the following claims.

What is claimed is:

1. An adjusting apparatus for light valve comprising
a base plate, which has a surface;
at least one adjusting module which is fixed upon one edge of said surface;
at least one repositioning module which is fixed upon the other edge of said surface and is opposite to said adjusting modules; and
a light valve which is clipped between said adjusting module and said repositioning module.

2. The adjusting apparatus for light valve according to claim 1, wherein said adjusting module comprises a fixing base, a sliding base, and an adjusting device, said fixing base fixed on said surface of said base plate and having a cavity on a side surface faced to said light valve, said sliding base being placed inside said cavity, said adjusting device being screwed to said fixing base and having one end pressing to said sliding base.

3. The adjusting apparatus for light valve according to claim 2, wherein surfaces of said sliding base of said adjusting module and said base plate respectively have guide-pins and guide-grooves according to each other.

4. The adjusting apparatus for light valve according to claim 2, wherein surfaces of said sliding base of said adjusting module and said fixing base respectively have guide-pins and guide-grooves according to each other.

5. The adjusting apparatus for light valve according to claim 2, wherein said repositioning module comprises a fixing base, a sliding base and at least one elastic device, said fixing base fixed on said surface of said base plate, one end of said elastic device connecting to said fixing base and the other end pressing to said sliding base.

6. The adjusting apparatus for light valve according to claim 5, wherein surfaces of said sliding base of said repositioning module and said base plate respectively have guide-pins and guide-grooves according to each other.

7. The adjusting apparatus for light valve according to claim 5, wherein surfaces of said sliding base of said repositioning module and said fixing base respectively have guide-pins and guide-grooves according to each other.

8. The adjusting apparatus for light valve according to claim 5, wherein said elastic device is a spring.

9. The adjusting apparatus for light valve according to claim 5, wherein said elastic device is an elastic piece.

10. The adjusting apparatus for light valve according to claim 5, wherein displacement direction of said adjusting device is parallel to elastic deformation direction of said elastic device.

11. The adjusting apparatus for light valve according to claim 5, wherein said light valve is fixed upon a fixing plate, one side surface of said sliding base of said adjusting module and of said sliding base of said repositioning module pressing to side surfaces of said fixing plate.

12. The adjusting apparatus for light valve according to claim 1, wherein said adjusting module comprises a first adjusting module and a second adjusting module, which are in accordance with said repositioning module having a first repositioning module and a second repositioning module.

13. The adjusting apparatus for light valve according to claim 12, wherein said first adjusting module and said second adjusting module move on the same plane.

14. The adjusting apparatus for light valve according to claim 12, wherein displacement direction of said first adjusting module and displacement direction of said second adjusting module are perpendicular to each other.

15. The adjusting apparatus for light valve according to claim 1, wherein said adjusting module and said repositioning module move on the same plane.
